(19) United States
(12) Patent Application Publication
(10) Pub. No.: US 2013/0200123 A1
(43) Pub. Date: Aug. 8, 2013

(54) MODULAR MOUNTING SYSTEM FOR VEHICLES

(71) Applicants: Xander Orozco, Grandview, MO (US); Louis Orozco, Grandview, MO (US)

(72) Inventors: Xander Orozco, Grandview, MO (US); Louis Orozco, Grandview, MO (US)

(21) Appl. No.: 13/366,910

(22) Filed: Feb. 6, 2012

Related U.S. Application Data
(60) Provisional application No. 61/595,345, filed on Feb. 6, 2012.

(51) Int. Cl. B60R 9/00

(52) U.S. Cl. 224/485

(57) ABSTRACT

A modular mounting system is provided for modifying the interior of a vehicle in a variety of configurations so that the vehicle is operable to securely receive a variety of equipment. The system includes a mounting base configured to be rigidly coupled to an interior surface of the vehicle and a base member removably attached to the mounting base. The system further includes a coupling mechanism that removably holds the base member relative to the mounting base.

### RELATED APPLICATION

This application is being filed contemporaneously with U.S. Provisional Application No. 61/595,345 (Docket No. 43250-PRO), filed Feb. 6, 2012, entitled MODULAR RETROFIT FOR ARMORED VEHICLES WITH CONSOLE AND STORAGE SYSTEMS, which is hereby incorporated in its entirety by reference herein.

### BACKGROUND

1. Field

The present invention relates generally to transporting equipment. More particularly, embodiments of the present invention concern a modular system that provides work and/or storage space in a variety of selectable configurations for a vehicle.

2. Description of the Related Art

Equipment is commonly transported in vehicles having a fixed storage space with little to no functionality. Although some vehicles may be equipped with various components, for example, shelving, such components are generally fit for only a particular purpose, which makes it difficult for such vehicles to accommodate any other purposes after the vehicles has been equipped with such components.

Accordingly, there is a need for a system for transporting equipment that does not suffer from the limitations of conventional systems, is versatile to permit use in a wide variety of applications, and has a simple design that is easy to use.

### SUMMARY

The following brief summary is provided to indicate the nature of the subject matter disclosed herein. While certain aspects of the present invention are described below, the summary is not intended to limit the scope of the present invention.

Embodiments of the present invention provide a modular mounting system that does not suffer from the problems and limitations of the prior art storage equipment set forth above.

A first aspect of the present invention concerns a modular mounting system for modifying the interior of a vehicle. The system broadly includes a mounting base, a shiftable base member, and a coupling mechanism. The mounting base that presents an upwardly facing receiving surface, with the mounting base configured to be rigidly coupled to an interior surface of the vehicle. The shiftable base member removably attached to the mounting base so as to be positioned on the receiving surface in a supporting position, with the base member being shiftable relative to the mounting base into and out of the supporting position. The coupling mechanism removably holds the shiftable base member relative to the receiving surface in the supporting position so that the base member is supported by the mounting base. The coupling mechanism includes a shiftable latch assembly shiftably mounted to the mounting base and spaced below the receiving surface. The coupling mechanism includes a latch element attached to the shiftable base member. The shiftable latch assembly and the latch element interengage one another in a latched position associated with the supporting position so as to restrict movement of the base member out of the supporting position.

A second aspect of the present invention concerns a modular mounting system for modifying the interior of a vehicle. The system broadly includes a mounting base, a shiftable base member, a coupling mechanism, and a release mechanism. The mounting base presents a receiving surface, with the mounting base configured to be rigidly coupled to an interior surface of the vehicle. The shiftable base member is removably attached to the mounting base so as to engage the receiving surface in a supporting position, with the base member being shiftable relative to the mounting base into and out of the supporting position. The coupling mechanism is operably supported by the mounting base, with the coupling mechanism removably coupling the shiftable base member relative to the receiving surface in the supporting position so that the base member is supported by the mounting base. The release mechanism is operable to permit decoupling of the base member from the receiving base.

The foregoing and other aspects are intended to be illustrative of the present general inventive concept and are not meant in a limiting sense. Many possible embodiments of the present general inventive concept may be made and will be readily evident upon a study of the following specification and accompanying drawings comprising a part thereof. Various features and subcombinations of present general inventive concept may be employed without reference to other features and subcombinations. Other objects and advantages of this present general inventive concept will become apparent from the following description taken in connection with the accompanying drawings, wherein is set forth by way of illustration and example, an embodiment of this present general inventive concept and various features thereof.

### BRIEF DESCRIPTION OF THE DRAWINGS

Preferred embodiments of the invention are set forth in the following description and shown in the drawings.

FIG. 1 is a perspective view of a modular mounting system secured in an armored vehicle in accordance with an exemplary embodiment of the present inventive concept;

FIG. 2 is a perspective view of the modular mounting system illustrated in FIG. 1, showing a mounting base and base members attached to the mounting base, with the base members supporting a computer, a seat, and containers;

FIG. 3 is a fragmentary upper perspective view of the modular mounting system illustrated in FIGS. 1 and 2, with bottom covers, coupling mechanisms, release mechanisms, and locking mechanisms being shown as exploded from a platform of the mounting base;

FIG. 4 is a fragmentary lower perspective view of the modular mounting system illustrated in FIGS. 1-3, showing one of the bottom covers, one of the coupling mechanisms, and one of the release mechanisms being shown as exploded from the platform to depict chambers and a lowermost surface of the platform;

FIG. 5 is a fragmentary lower perspective view of the modular mounting system illustrated in FIGS. 1-4, with bottom covers secured to the platform;

FIG. 6 is a fragmentary upper perspective view of the modular mounting system illustrated in FIGS. 1-5, showing part of the platform in phantom lines to depict the coupling, release, and locking mechanisms, with a latch assembly of the coupling mechanism being in a latched position and the release mechanism in a holding condition, and with the locking mechanism being sectioned to show a lever, protrusion, and springs of the locking mechanism;

FIG. 7 is a fragmentary upper perspective view of the modular mounting system illustrated in FIGS. 1-6, showing one of the latch assemblies, the release mechanism, and the locking mechanism exploded from one of the bottom covers;

FIG. 8 is a fragmentary upper perspective view of the modular mounting system illustrated in FIGS. 1-7, with the platform shown in phantom and showing the locking mechanism shifted out of a locked condition into an unlocked condition to permit sliding movement of the release mechanism in the indicated fore-and-aft direction;

FIG. 9 is a fragmentary upper perspective view of the modular mounting system similar to FIG. 8, but showing the release mechanism shifted into the releasing condition, with latch fingers of the latch assemblies being urged by springs into the unlatched position;

FIG. 10 is a fragmentary lower perspective view of the modular mounting system illustrated in FIGS. 1-9, showing one of the base members exploded to depict a base, hinges, and crossbars, with latch pins of the coupling mechanism being shown as exploded from one of the crossbars;

FIG. 11 is a fragmentary lower perspective view of the modular mounting system illustrated in FIGS. 1-10, showing one of the base members in an intermediate position on the platform where hinges of the base member are shiftably received in slots presented by the platform;

FIG. 12 is a fragmentary upper perspective view of the modular mounting system illustrated in FIGS. 1-11, showing one of the base members in phantom lines in a disengaged position relative to the platform, in the intermediate position on the platform, and in a supporting position on the platform where the base member rests on the upper platform surface;

FIG. 13 is a fragmentary upper perspective view of the modular mounting system illustrated in FIGS. 1-12, showing one of the base members cross sectioned to show the underlying coupling and release mechanism, and showing the base member in the supporting position where the base members rests on the platform shown in phantom lines, with the release mechanism being in the releasing condition so that the latch assembly is urged by springs into the unlatched position;

FIG. 14 is a fragmentary upper perspective view of the modular mounting system similar to FIG. 13, but with the release mechanism shifted into the holding condition and the latch assembly is in the latched position to engage the latch pins and secure the base member in the supporting position; and

FIG. 15 is a fragmentary lower perspective view of the modular mounting system illustrated in FIGS. 1-14, showing the base member secured in the supporting position.

The drawing figures do not limit the present inventive concept to the specific embodiments disclosed and described herein. The drawings are not necessarily to scale, emphasis instead being placed upon clearly illustrating the principles of the illustrated embodiment.

### DETAILED DESCRIPTION OF THE PREFERRED EMBODIMENTS

The present inventive concept is susceptible of embodiment in many forms. While the drawings illustrate, and the specification describes, certain embodiments of the invention, it is to be understood that such disclosure is by way of example only. The principles of the present inventive concept are not limited to the particular disclosed embodiments.

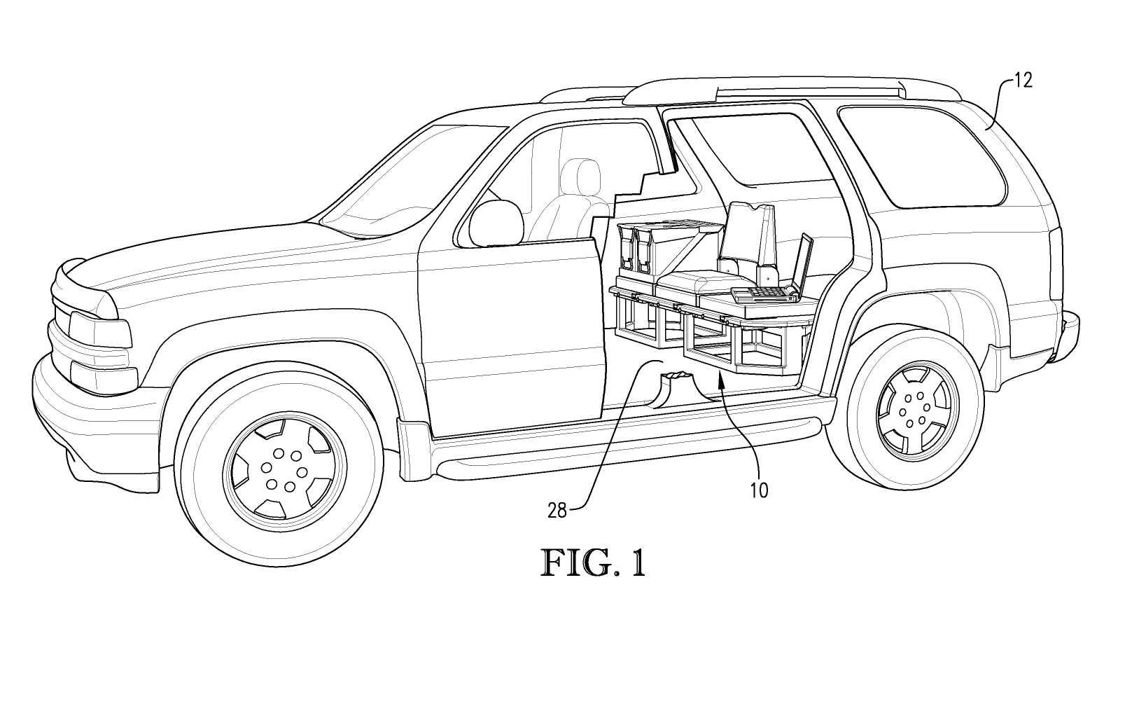

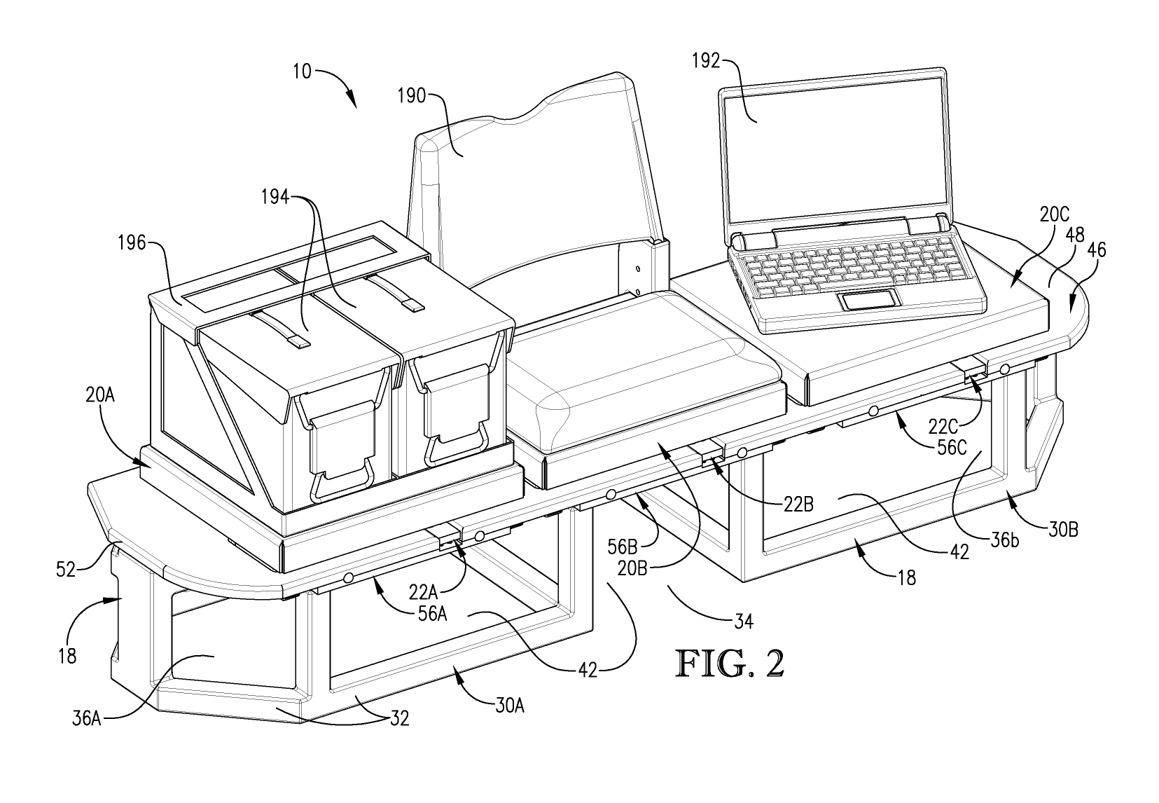

With initial reference to FIGS. 1 and 2, a modular mounting system 10 is mounted to an armored vehicle 12 in accordance with an exemplary embodiment of the present inventive concept. The illustrated vehicle 12 is preferably a self-powered automobile, but could be installed as part of a towed vehicle. Furthermore, the system 10 could be secured to other powered vehicles such as, but not limited to, a plane, boat, or another type of ground vehicle without deviating from the scope of the present inventive concept. Also, while the system 10 is preferably retrofitted onto the vehicle as part of a vehicle customization process, it is also within the ambit of the present invention where the system 10 is provided with the vehicle 12 as original equipment.

The system 10 generally includes an elongated mounting base 18 and a plurality of selectively reconfigurable shiftable base members 20A, 20B, 20C that can be shifted into and out of a supporting position (see FIG. 2). The base members 20 are each associated with a respective coupling mechanism 22A, 22B, 22C that removably holds and secures the shiftable base member 20A, 20B, 20C to the mounting base 18 in the supporting position. Preferably, the base members 20 can be secured in any of three possible mounting locations along the mounting base 18—a center location, a left-side location, and a right-side location. However, it is within the scope of the present invention where the mounting base provides either less than three or greater than three mounting locations. Also, while the exemplary embodiment of the present inventive concept illustrates the system 10 with three shiftable base members 20A, 20B, 20C, the system 10 may be equipped with any number of shiftable base members 20A, 20B, 20C without deviating from the scope of the present inventive concept. For instance, the system 10 may be equipped with between one and six shiftable base members 20A, 20B, 20C without deviating from the scope of the present inventive concept.

The illustrated mounting base 18 is preferably rigidly coupled to an interior floor 28 of the vehicle 12 via left and right support structures 30A, 30B of the mounting base 18. The left and right support structures 30A, 30B are securely fastened to the floor 28 with fasteners (not shown) such as, but not limited to, bolts or the like. Each of the support structures 30A, 30B includes a plurality of horizontal floor-engagement bars 32 welded together to form a lowermost portion of the support structure 30. The support structures 30A, 30B are preferably spaced from each other by an intermediary region 34 and respectively define footprints 36A, 36B.

Preferably, the support structures 30A, 30B further include a plurality of vertical spacing bars 42 extending generally perpendicular to the floor-engagement bars 32 of each of the support structures 30A, 30B. Secured to an opposite end of the spacing bars 42 relative to the floor-engagement bars 32 is an elongated platform 46 of the mounting base 18. The illustrated platform 46 preferably extends in a lateral direction and is vertically spaced from the floor 28 of the vehicle 12 by the spacing bars 42. Thus, a cavity 44 is defined between the floor 28 of the vehicle 12 and the platform 46. As will be appreciated, the size of the cavity 44 is variable and determined by a length of the spacing bars 42. While the illustrated orientation and positioning of the platform 46 is preferred, it is within the scope of the present invention where the platform 46 is secured in an alternative position. For instance, the system 10 could be mounted to a generally upright wall so that the length of the platform 46 extends in a fore-and-aft direction relative to the vehicle 12 or in an upright direction.

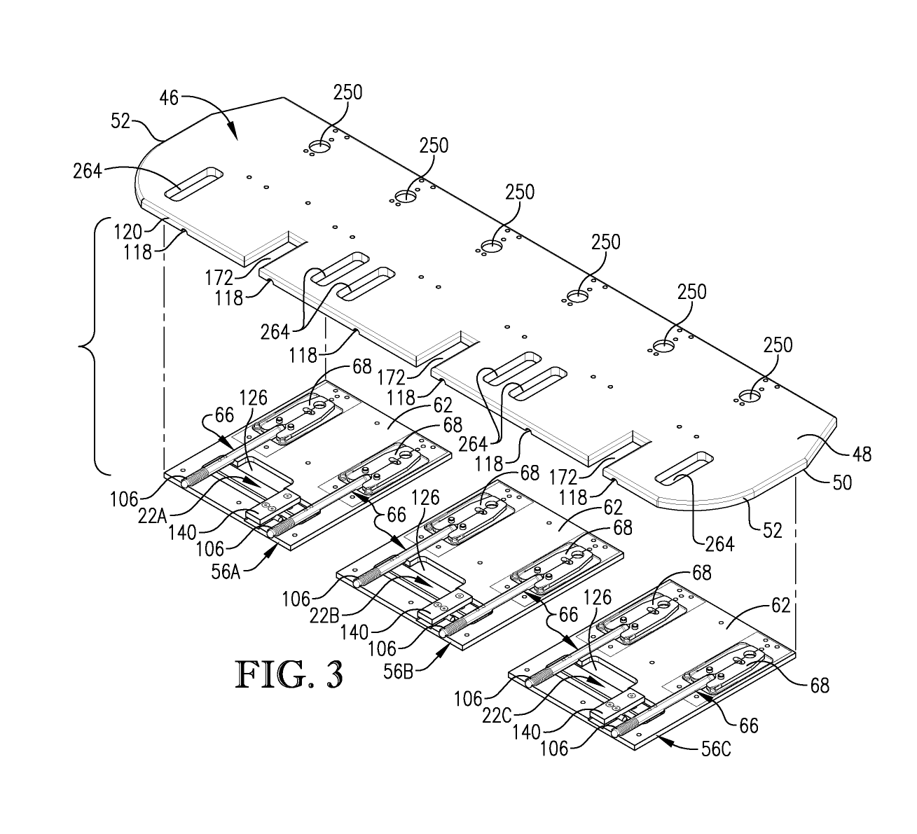

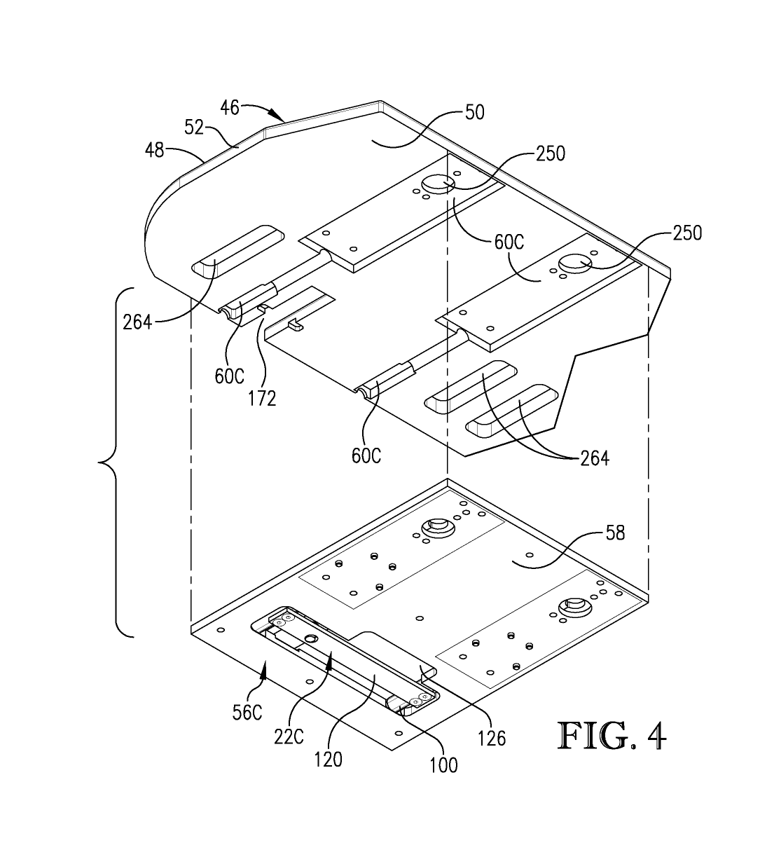

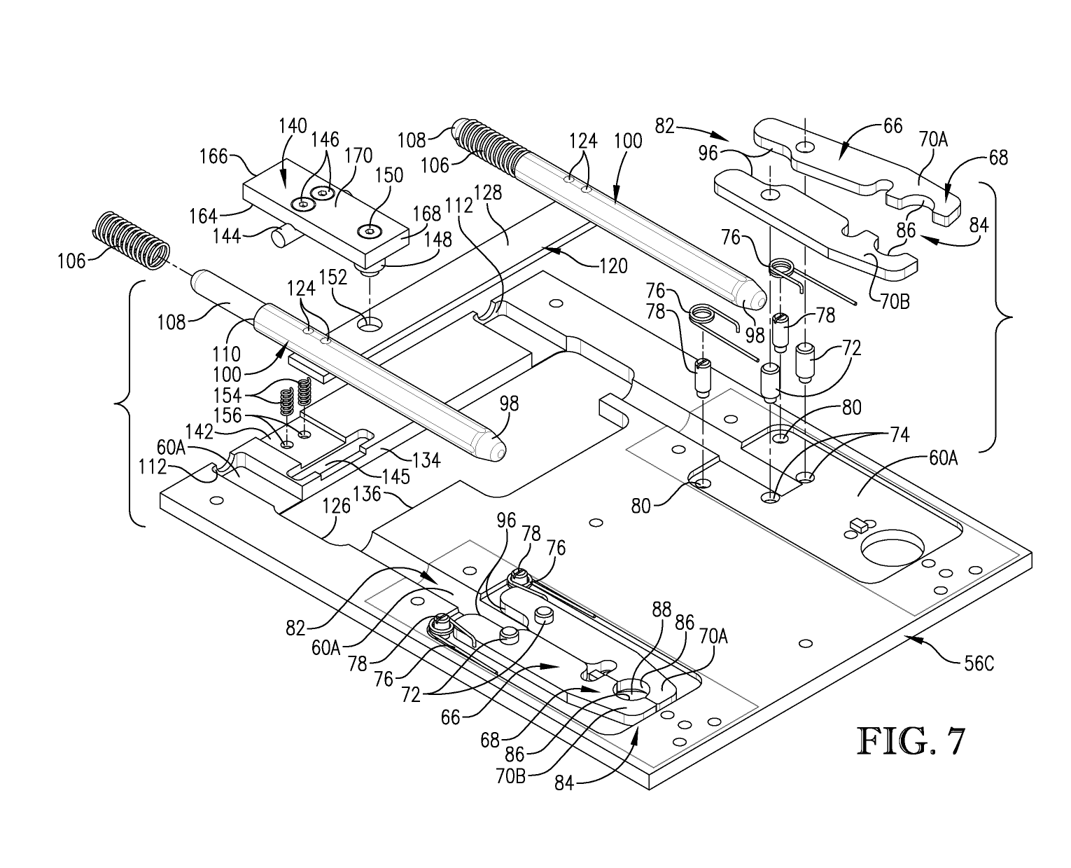

The platform 46 presents an upwardly-facing receiving surface 48 and a downwardly-facing lowermost surface 50 that cooperatively define a common outermost margin 52 of the system 10 (see FIG. 3). The receiving surface 48 is sized and shaped to receive one or more of the plurality of shiftable-base members 20A, 20B, 20C, which will be further discussed hereafter. The lowermost surface 50 includes generally rectangular sockets 50A and grooves 50B (see FIG. 4). The downwardly-facing lowermost surface 50 is sized and shaped to receive one or more of a plurality of bottom covers 56A, 56B, 56C of the mounting base 18. Each of the bottom covers 56A, 56B, 56C presents an upper surface 57 and a lowermost surface 58. The upper surface 57 includes rectangular sockets 57A and grooves 57B (see FIGS. 7-9) that partly form the respective chambers 60. The bottom covers 56 are secured to the lowermost surface 50 with fasteners such as, but not limited to, bolts or the like. When secured to the platform 46, the bottom covers 56A, 56B, 56C cooperate with the downwardly-facing lowermost surface 50 of the platform 46 to form independent chambers 60A, 60B, 60C (see, e.g., FIG. 4). Preferably, respective pairs of sockets 50A,57A and grooves 50B,57B are aligned with one another to cooperatively form the chambers 60.

The chambers 60A, 60B, 60C are sized and shaped to respectively house, at least partially, the coupling mechanisms 22A, 22B, 22C. The illustrated latch assemblies 65 are vertically positioned entirely between the receiving surface 48 and the lowermost surface 58. The latch assemblies 65 are preferably positioned and captured within respective pairs of sockets 50A, 57A that partly define the chambers 60. It is foreseen, however, that the chambers 60A, 60B, 60C may be entirely formed in only one of the downwardly-facing lowermost surface 50 of the platform 46 or the upwardly-facing abutment surface 62 of the bottom covers 56A, 56B, 56C to substantially house the coupling mechanisms 22A, 22B, 22C without deviating from the scope of the present inventive concept.

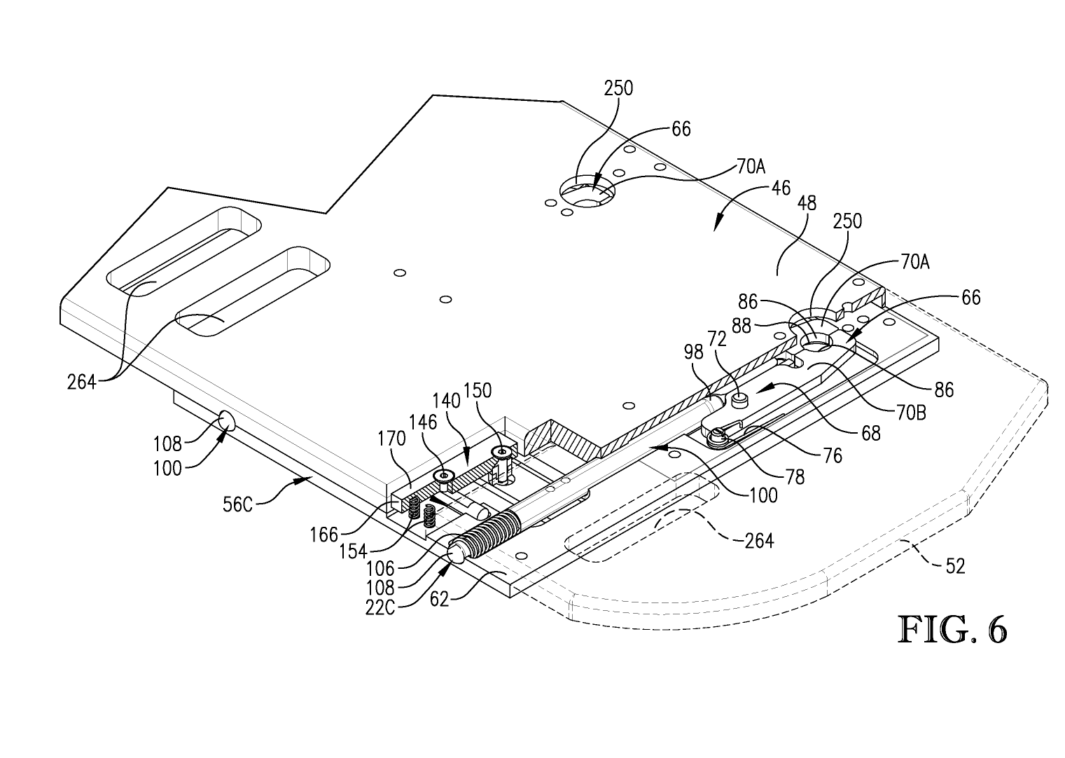

Turning to FIGS. 6-9, each of the coupling mechanisms 22A, 22B, 22C includes a latch assembly 65 and latch pins (as will be discussed). The shiftable latch assembly 65 preferably permits selective independent coupling and decoupling of base members 20A, 20B, 20C with the mounting base 18. When coupled to the mounting base 18 at one of the three mounting locations, the base members 20 are preferably secured in the supporting position. The system 10 also has release mechanisms 66 housed respectively within chambers 60A, 60B, 60C and mounted between the mounting base 18 and bottom covers 56A, 56B, 56C. At least a portion of each release mechanism 66 is operable to be horizontally shifted with respect to the mounting base 18 and bottom covers 56A, 56B, 56C between a holding condition and a releasing condition.

The latch assemblies 65 and release mechanisms 66 are preferably spaced entirely below and substantially covered by the receiving surface 48. Also, as will be discussed in greater detail, the latch assembly 65 and release mechanism 66 are shiftable in a plane that is preferably generally parallel to a horizontal plane defined by the receiving surface 48. The coupling mechanisms 22 are preferably constructed so that the latch assemblies 65 are attached to the mounting base 18. However, for some aspects of the present invention, the latch assemblies 65 could be mounted to corresponding base members 20, with the latch pins being mounted to the mounting base 18.

Each latch assembly 65 preferably includes a pair of opposing latch fingers 70A, 70B that are both movable relative to each other and the respective bottom cover 56. However, it is within the ambit of the present invention where only one of the latch fingers 70A, 70B is movable relative to the bottom cover 56. Also, for some aspects of the present invention, the latch assembly could have a single latch finger or more than two latch fingers to secure the base member.

Each latch finger 70A, 70B is secured to one of the bottom covers 56A, 56B, 56C via a fastener 72, such as a bolt or the like, that defines an axis of rotation or pivot for the latch finger 70A, 70B secured thereto. The fasteners 72 extend into and are secured to apertures 74 (see FIG. 7) presented by corresponding bottom covers 56A, 56B, 56C. Preferably, the latch fingers 70 move in a plane that is generally parallel to the plane of the receiving surface 48.

A plurality of resilient elements or springs 76 are positioned within each of the chambers 60A, 60B, 60C, with each spring 76 positioned in engagement with a respective latch finger 70. Each spring 76 is secured to one of the bottom covers 56A, 56B, 56C via a fastener 78 such as, but not limited to, a bolt or the like. The fasteners 78 extends into and are secured to apertures 80 (see FIG. 7) presented by corresponding bottom covers 56A, 56B, 56C.

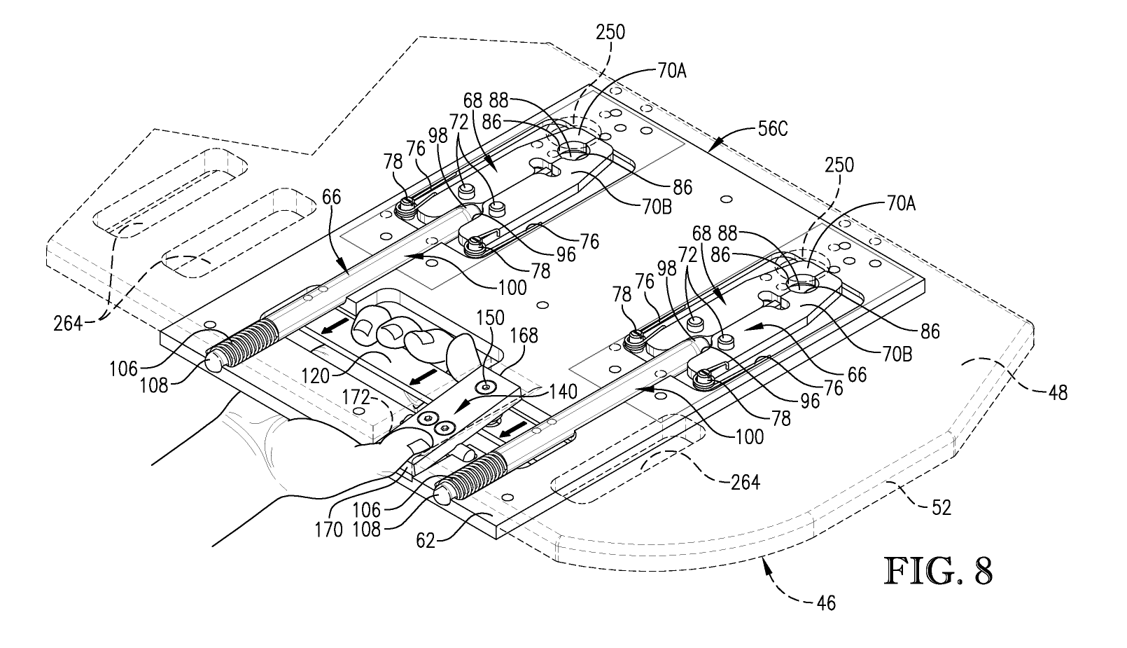

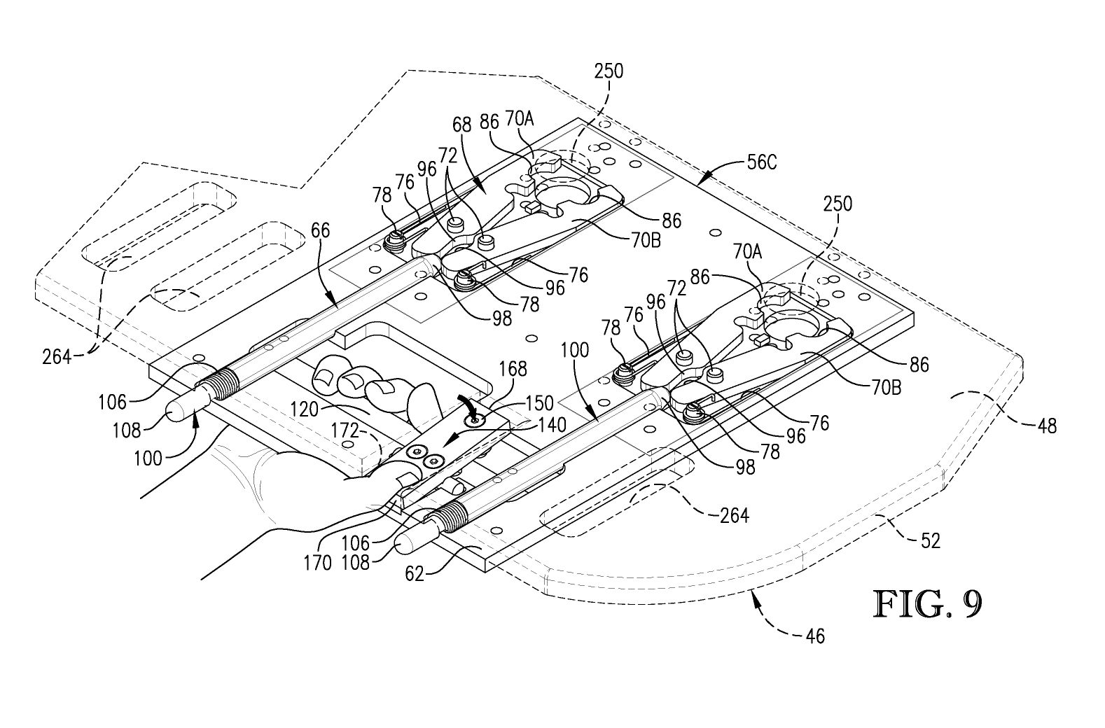

The illustrated springs 76 are preferably operable to urge the latch finger 70A, 70B to pivot about the fasteners 72 so that the latch elements 68 are generally urged away from a latched position (see FIGS. 7 and 8) and into an unlatched position (see FIG. 9). In other words, the springs 76 preferably operate so that the latch assembly 65 has a normally-open configuration. In the latched position, the latch fingers 70A, 70B are spaced from each other at proximal inner ends 82 thereof and abutted together at distal outer ends 84 thereof so that opposing half-circle pinching surfaces 86 are closed to collaboratively form a circular pin-receiving opening 88. In the unlatched position, each of the latch finger 70A, 70B are abutted together at the inner ends 82 (or at least closer together relative the latched position) and spaced from each other at the outer ends 84 so that the pinching surfaces 86 are spaced from each other and the opening 88 is expanded. Preferably, each latch assembly 65 is substantially entirely positioned in the respective chamber 60 in both the latched and unlatched positions. For some aspects of the present invention, the latch assembly 65 could be configured so that at least one spring urges the latch fingers into the latched position (i.e., where the latch assembly 65 has a normally-closed configuration) without departing from the scope of the present invention.

Additionally, when each latch assembly 65 is in the latched position, the inner ends 82 thereof define a socket 96. Each socket 96 is operable to receive a proximal inner tip 98 of an elongated release pin or shaft 100 of the release mechanism 66. Each of the chambers 60A, 60B, 60C receive shafts 100, which are horizontally shiftable within their respective chambers 60A, 60B, 60C. The illustrated shafts 100 are slidable between a holding condition (see FIG. 8) and a releasing condition (see FIG. 9).

Each release mechanism 66 includes springs 106, with each spring 106 secured around a distal outer tip 108 of the respective shaft 100. The outer tip 108 is located at a distal end of the shaft 100 opposite the inner tip 98. When each of the shafts 100 and corresponding coupling mechanisms 22A, 22B, 22C are respectively assembled within the chambers 60A, 60B, 60C, the spring 106 is abuttingly trapped between a shaft abutment surface 110 on each of the shafts 100 and a bottom plate abutment surface 112 in each of the chambers 60A, 60B, 60C (see FIG. 7). In this manner, each shaft 100 is horizontally shifted or biased away from the bottom plate abutment surfaces 112 and toward the sockets 96.

Turning to FIGS. 8 and 9, when the shafts 100 are removed from the sockets 96 (i.e., where the shafts 100 are in the releasing condition), the biasing force of the springs 76 urges the latch fingers 70A, 70B to be pivoted about the fasteners 72 so that the inner ends 82 of the latch finger 70A, 70B become abutted against each other (see FIG. 9). Furthermore, the outer ends 84 of the latch finger 70A, 70B become spaced apart along with the opposing half-circle pinching surfaces 86. As a result, the latch assembly 65 is urged by the springs 76 toward the unlatched position. Thus, the unlatched position is generally associated with the releasing condition of the release mechanism 66.

As the inner tips 98 of the shafts 100 are shifted into engagement with the sockets 96 (see FIG. 8), the inner tips 98 cause the latch fingers 70A, 70B to pivot about the fasteners 72 so that the inner ends 82 of the latch finger 70A, 70B become spaced apart from each other. Furthermore, the outer ends 84 of the latch finger 70A, 70B become abutted against each other thereby forming the circular void 88 via the opposing half-circle pinching surfaces 86 (see FIGS. 6 and 7). In other words, upon receipt of the inner tips 98 of the shafts 100 within the sockets 96, the biasing force of the springs 76 is overcome, which causes the latch fingers 70 to pivot or move from the unlatched position to the latched position. Thus, the latched position is generally associated with the holding condition of the release mechanism 66.

A lower portion 114 of an aperture 116 is formed through each of the bottom plate abutment surfaces 112 (see FIG. 7). An upper portion 118 of the aperture 116 (see FIG. 3) is formed through a side surface 119 of the platform 46. Thus, aperture portions 114, 118 cooperatively form the aperture 116 when the bottom plates 56A, 56B, 56C are attached to the platform 46 (see FIG. 6). Each aperture 116 is sized and shaped to at least partially receive the outer tip 108 of the respective shaft 100 when the shafts 100 are horizontally shifted adjacent the bottom plate abutment surfaces 112 (see FIG. 9). In this manner, the apertures 116 permit a portion of the shaft 100 to project out of the platform when the shafts 100 are horizontally shifted into the releasing condition. With the shafts shifted adjacent the abutment surfaces 112, the springs 100 are compressed and the inner tips 98 are disengaged from the sockets 96 (see FIG. 9).

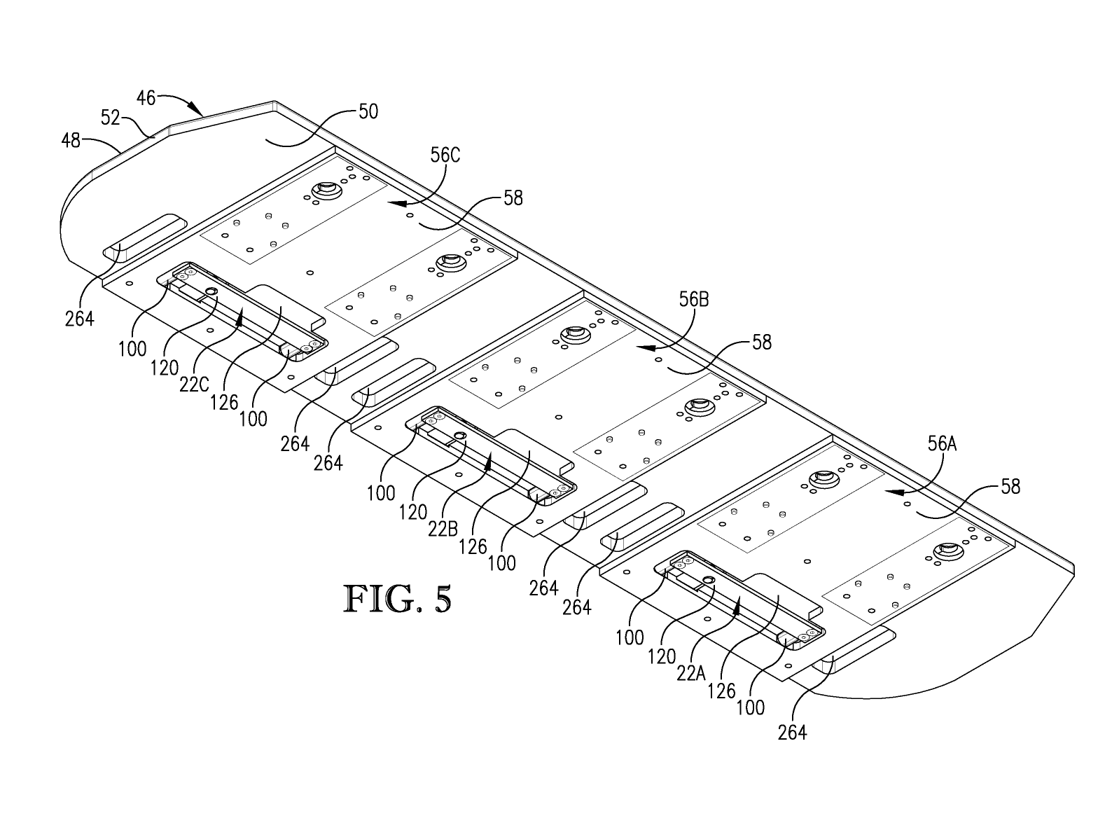

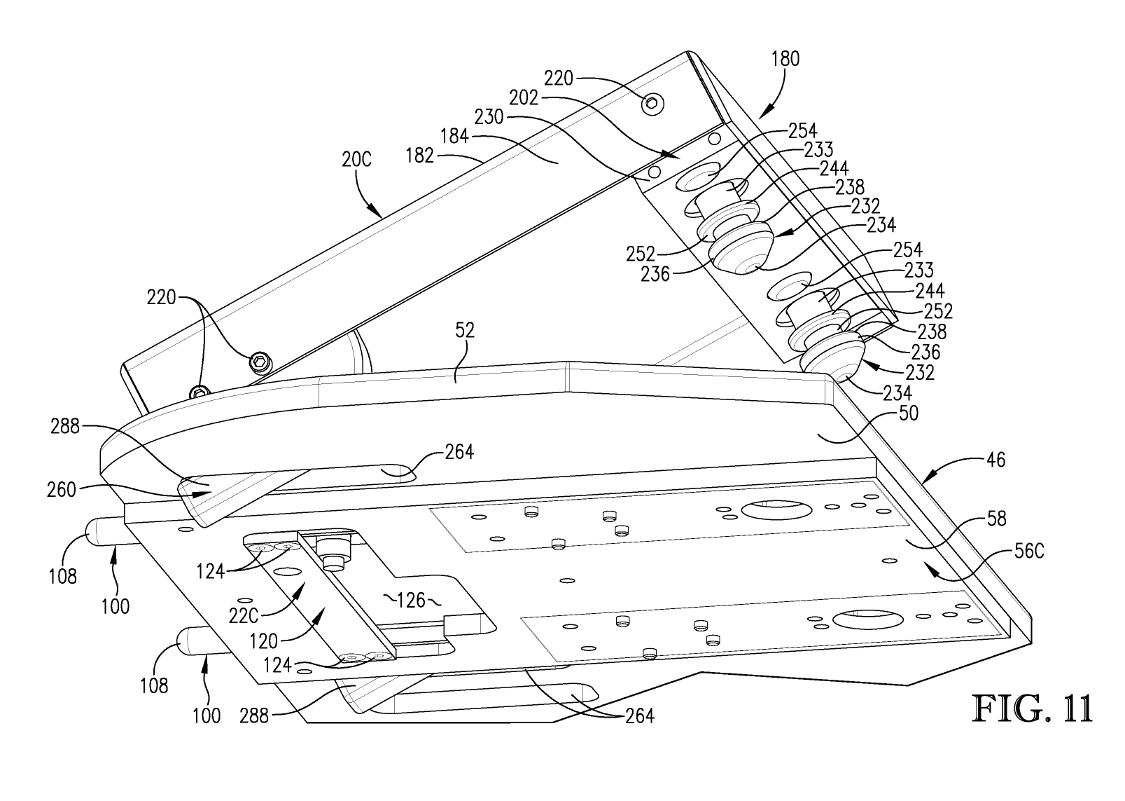

Connecting each pair of shafts 100 is a lateral connector or handle 120 of the release mechanism 66. The handle 120 extends between and is secured to each of the pair of shafts 100 adjacent proximal ends thereof with fasteners 124 (see FIG. 11) such as, but not limited to, bolts or the like. Each of the chambers 60A, 60B, 60C houses one of the handles 120. The handles 120 are generally positioned within and exposed by a window 126 defined by a respective bottom cover 56A, 56B, 56C (see FIG. 5). The handle 120 includes a gripping surface 128 (see FIG. 7) about a perimeter thereof that is accessible to a user of the system 10 via the window 126. The gripping surface 128 is operable to alternately abut side surfaces 134, 136 of the window 126 (see FIG. 7) when the shafts 100 are shifted to respective releasing and holding conditions. In this manner, the side surfaces 134, 136 define a fore-and-aft range of shifting movement for the release mechanisms 66.

While the system 10 preferably includes the illustrated release mechanism 66, the principles of the present invention are applicable where the release mechanism 66 has an alternative construction. For instance, the release mechanism 66 could be constructed to engage another part of the latch assembly 65 when the latch assembly is in the latched condition.

Turning to FIGS. 6-9, the system 10 also preferably includes a locking mechanism 140. The locking mechanism 140 is pivotably mounted at least partially within a recess 142 presented by a respective bottom cover 56A, 56B, 56C. Each of the locking mechanisms 140 includes a lever 143 and a lateral rocking element 144 housed in a notch support 145 formed in the bottom cover 56A, 56B, 56C. The locking mechanism 140 permits each of the locking mechanisms 140 to rock or pivot relative to its notch support 145 in the bottom cover 56A, 56B, 56C. The lever 143 of the locking mechanism 140 is secured to the rocking element 144 via fasteners 146 such as, but not limited to, bolts or the like. Extending perpendicularly from an end of each lever 143 is a protrusion 148 of the locking mechanism 140, which is secured thereto via a fastener 150 such as a bolt or the like. Each of the protrusions 148 are sized and shaped to mate with and be received by, at least partially, an aperture 152 formed at least partially through the handle 120.

Each locking mechanism 140 further includes a pair of resilient elements or springs 154 secured in the recess 142 by positioning the springs in corresponding apertures 156. Each spring 154 extends from one of the apertures 156 to abut an underside 164 of the locking mechanism 140. The springs 154 urge an exposed outer end portion 166 of the locking mechanism 140 away from the recess 142, which causes the locking mechanism 140 to pivot about the rocking element 144 (see FIG. 6). This pivoting, in turn, causes an inner end portion 168 of the locking mechanism 140, from which the protrusion 148 extends, to move in a direction toward the handle 120 and into a locked condition.

The biasing force of the springs 154 may be overcome when the user depresses an upwardly facing contact surface 170 of the locking mechanism 140 (see FIG. 8). Such movement allows the locking mechanism to be shifted by the user from the locked condition to an unlocked condition where the locking mechanism 140 permits sliding fore-and-aft movement of the release mechanism 66. The contact surface 170 is aligned with and exposed by a cutout portion 172 formed in the platform 46 to permit user access to the locking mechanism 140. It is foreseen that the contact surface 170 may be formed with a texture, such as ribbing or the like, operable to increase friction thereby facilitating a secure connection with the user and the locking mechanism 140.

Turning to FIGS. 8 and 9, with the contact surface 170 depressed, the handle 120 is operable to be shifted back and/or forth along the fore-and-aft direction. If the handle 120 is shifted so that the shafts 100 extend into the sockets 96 (so that the latch assemblies 65 are in the latched position), the aperture 152 is caused to be aligned with the protrusion 148. Upon such alignment, the protrusion 148 is operable to extend into the aperture 152 if the contact surface 16 is released. In this manner, the handle 120 is locked and unable to be shifted back and/or forth. thereby locking the handle 120. Alternatively, if the contact surface 170 is depressed and the handle 120 is shifted so that the shafts 100 are not extending into the sockets 96 (so that the latch assemblies 65 are in the unlatched position), the aperture 152 is misaligned with the protrusion 148. Thus, the protrusion 148 is unable to extend into the aperture 152, thereby permitting further movement or shifting of the handle 120 when the contact surface 170 is released by the user.

The illustrated construction of the locking mechanism 140 is preferred. However, the locking mechanism 140 could have an alternative construction (e.g., for holding the release mechanism in the locked condition) without departing from the scope of the present invention. Furthermore, for some aspects of the present invention, the system 10 could be devoid of locking mechanism 140.

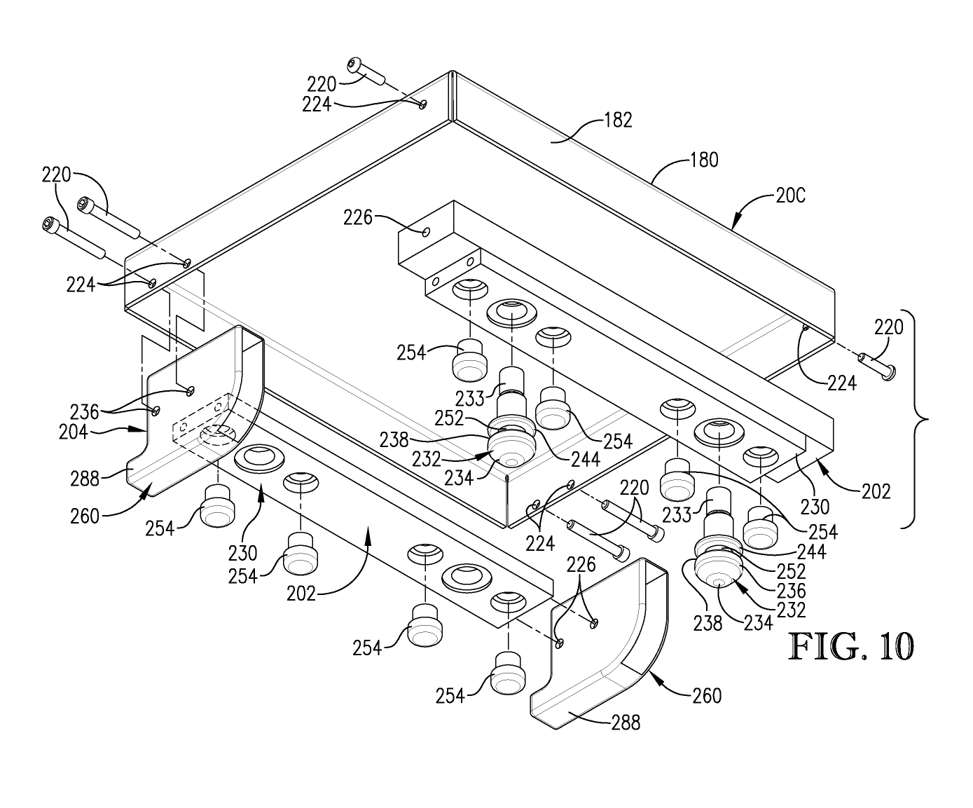

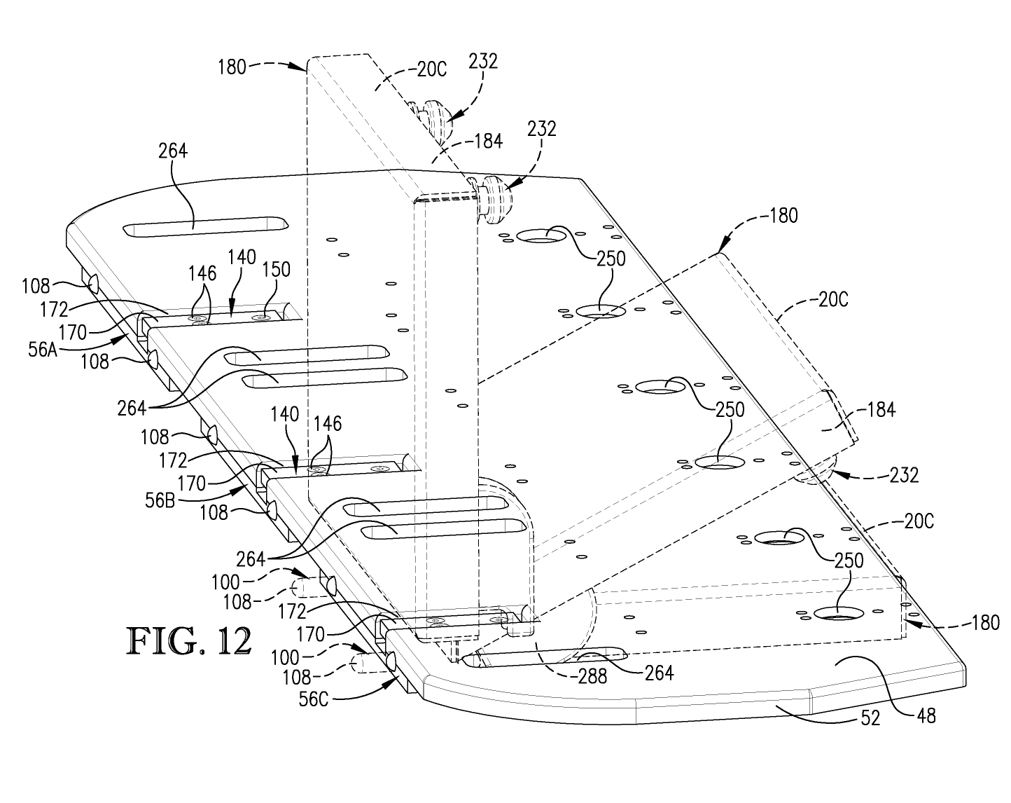

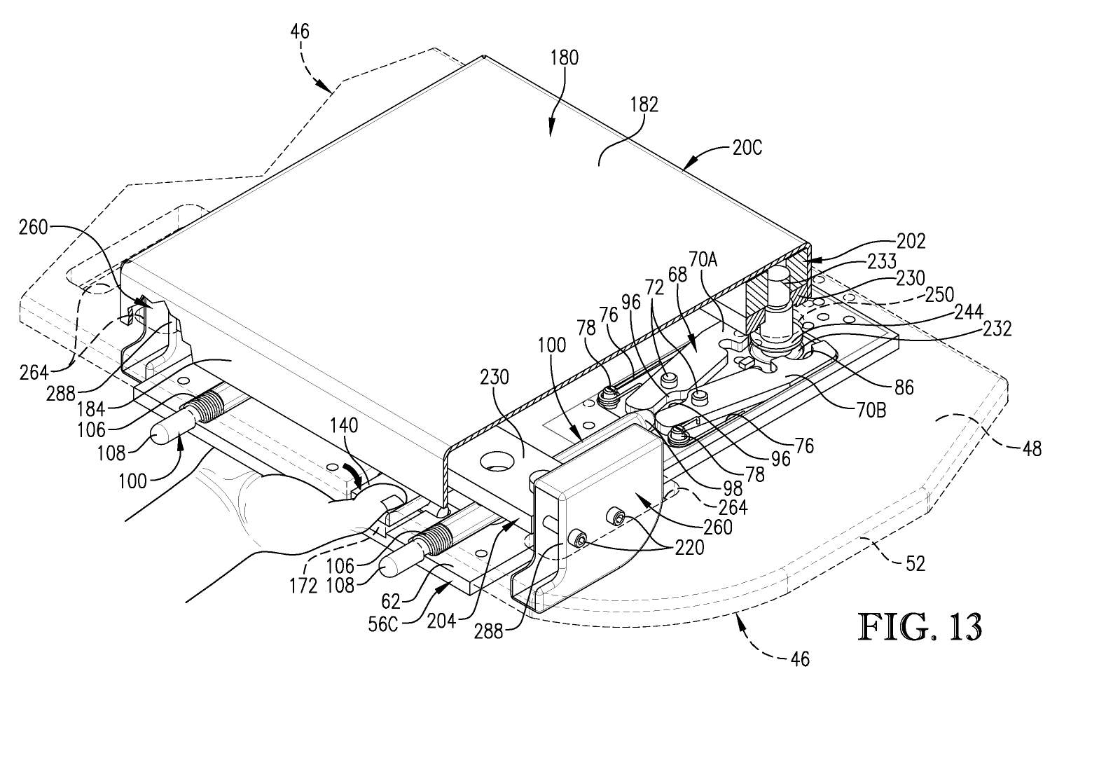

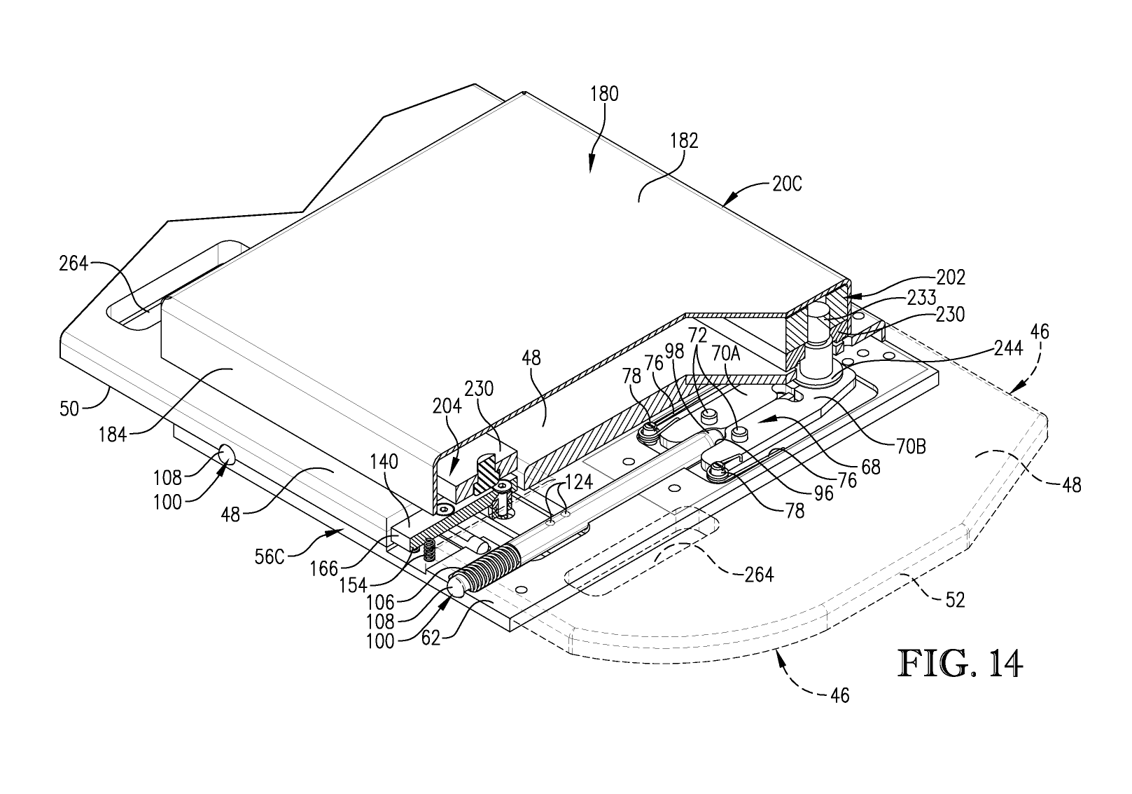

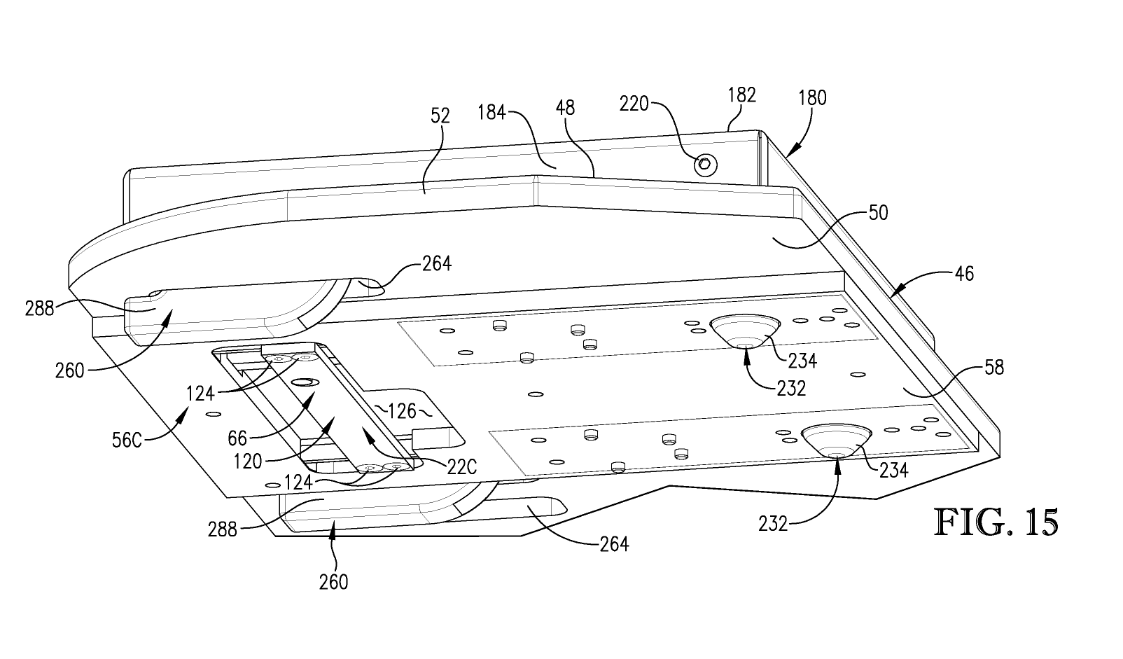

Turning to FIGS. 10-15, each base member 20A, 20B, 20C includes a base 180 having a top wall 181 and a perimeter sidewall 182 that depends therefrom, as illustrated in FIGS. 12-15. Each base 180 is preferably operable to securely receive and support one or more of a variety of tools or peripherals, such as, but not limited to, a seat 190, a laptop or computer 192, containers 194 in a case 196, and/or the like. It is within the ambit of the present invention to adapt the base 180 for other attachments. Additionally, it is foreseen that the base 180 may also be used without a peripheral. For instance, the base member could be employed as a desktop or other working surface.

Each of the shiftable base members 20A, 20B, 20C also includes base member connection assemblies 202, 204. The connection assemblies 202, 204 are securely fastened to the sidewall 182 of each of the bases 180 via fasteners 220 such as, but not limited to, bolts or the like. The fasteners 220 extend through apertures 224 in each of the sidewalls 182 and into apertures 226 in the connection assemblies 202, 204.

The connection assembly 202 includes a crossbar 230. As mentioned previously, the coupling mechanisms 22 include a plurality of latch pins 232 that are attached to the crossbar 230. As will be discussed, the latch pins 232 are preferred for releasable engagement with the latch assemblies 65. However, the connection assembly 202 could have alternative structure for engaging the latch assemblies 65 without departing from the scope of the present invention. While the latch pins 232 are preferably attached to the base members 20, it is also within the scope of the present invention where the base members carry the latch assemblies 65 and the latch pins 232 are attached to the mounting base 18.

The latch pin 232 presents a threaded end 233 and a conical end 234 that flares circumferentially outward to define an outermost side perimeter 236 that terminates at an uppermost surface 238. Spaced from the uppermost surface 238 is a washer 244 integrally formed as part of the latch pin 232. Each latch pin 232 is sized and shaped to be received through an aperture 250 formed in the platform 46 of the mounting base 18 and at least partially housed in the chamber 60A, 60B, 60C. A groove 252, formed between the end 234 and washers 244, is aligned with and is operable to be engaged by the latch fingers 70 when the latch fingers 70 are in the latched position. Thus, with the fingers 70 in the latched position, the latch pin 232 is secured in and restricted from moving relative to the chamber 60A, 60B, 60C. The crossbar 230 further includes a plurality of feet 254 operable to abut the receiving surface 48 of the mounting base 18 when the base members 20A, 20B, 20C are secured to the mounting base 18. In this manner, the feet 254 further support any peripherals secured to the base members 20A, 20B, 20C.

Each connection assembly 204 includes a pair of hinges 260 on respective sides of the base 180. The hinges are operable to be received by slots 264 formed in the mounting base 18. A tab 288 of each hinge 260 engages the platform 46 so that the base members 20 can rotate about a pivot axis. Furthermore, the tabs 288 restrict removal of the base members 20A, 20B, 20C from the slots 264 when the base members 20A, 20B, 20C are also secured to the mounting base 18 by the latch assemblies 65. Another crossbar 230 is secured between the pair of hinges 260. The crossbar 230 includes a plurality of feet 254 that abut the receiving surface 48 of the mounting base 18 when the base member 20A, 20B, 20C is secured to the mounting base 18. Again, the feet serve to support the base member and any peripherals secured to the base member 20A, 20B, 20C.

To use the system 10, the base member 20 is preferably permanently installed in the vehicle 12, e.g., by attachment to the floor 28 of the vehicle 12. Depending on an intended application of the system 10, one or more base members 20A, 20B, 20C are equipped with desired peripherals. For instance, the seat 190 can be attached to allow seating of the user (e.g., while the vehicle 12 is moving and/or during use of other peripherals mounted to the system 10). Any selected peripherals are secured to the base members 20A, 20B, 20C via fasteners such as, but not limited to, bolts, an adhesive, or the like. Then, the base members 20A, 20B, 20C (and any peripherals) are ready to be mounted to the mounting base 18.

Each base member 20A, 20B, 20C is operable to be mounted to the mounting base 18 independently of the other base members 20 and in any vacant mounting location on the mounting base 18. The exemplary embodiment illustrates three possible mounting locations, that is, the center location, the left-side location, and the right-side location. Upon selection of one of the vacant locations, the hinges 260 are inserted in corresponding slots 264. The exposed locking mechanism 140 associated with a respective one of the vacant spots is depressed via the contact surface 170, which removes the protrusion 148 from the aperture 152 in the handle 120, and thereby unlocks the handle 120. This allows the release mechanism 66 to be shifted laterally from the holding condition to the releasing condition.

In one mode of latching and securing the base member 20 in the supporting position, the handle 120 is shifted toward the user by applying force to the gripping surface 128. This causes the shafts 100 to move toward the user and out of the sockets 96 so that the latch assemblies 65 open into the unlatched position. The system 10 is designed to permit simultaneous one-handed manipulation of the locking mechanism 140 and the handle 120 by the user. With the latch assembly 65 unlatched and the hinges 260 in the slots 264, the base member 20A, 20B, 20C is then pivoted about the pivot axis so that the latch pins 232 are aligned with and received by apertures 250 in the platform 46. The latch pins 232 pass through the platform 46 and into the chamber 60A, 60B, 60C so that groove 252 is aligned with fingers of latch assembly 65. The handle 120 is then released by the user and/or urged by the user to return to the holding condition, which causes the release mechanism 66 to move into the sockets 96 so that the fingers close and engage the groove 252. The locking mechanism 140 can then be released by the user so that the locking mechanism 140 engages the release mechanism 66. In this manner, each of the base members 20A, 20B, 20C are locked to the mounting base 18 independent of each other.

It is also within the ambit of the present invention where the base member is shifted into the latching position by an alternative method. For instance, the latch assembly 65 and release mechanism 66 could be configured so that the fingers of the latch assembly 65 open as the latch pins 232 are pushed downwardly into the opening 88 (i.e., so that the latch pins 232 engage and expand the fingers apart from each other).

To remove a base member 20 from the mounting base 18, the locking mechanism 140 is again disengaged from the handle 120. Then, the handle 120 and shafts 100 are shifted from the holding condition to the releasing condition. Consequently, the latch assembly 65 opens to the unlatched position so that the latch pin 232 is released. The base member 20 can then be pivoted to remove the latch pins 232 from apertures 250. Finally, the base member 20 is moved to disengage the hinges 260 from slots 264.

Accordingly, the present inventive concept provides the system 10 that is modular, is easily installed in the vehicle 12 in any one of a variety of selectable configurations, and is convertible to a variety of configurations after installation, thereby accommodating an intended use of the system 10.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventors hereby state their intent to rely on the Doctrine of Equivalents to determine and assess the reasonably fair scope of the present invention as pertains to any apparatus not materially departing from but outside the literal scope of the invention as set forth in the following claims.

What is claimed is:

1. A modular mounting system for modifying the interior of a vehicle, said system comprising:
a mounting base that presents an upwardly facing receiving surface, with the mounting base configured to be rigidly coupled to an interior surface of the vehicle;
a shiftable base member removably attached to the mounting base so as to be positioned on the receiving surface in a supporting position, with the base member being shiftable relative to the mounting base into and out of the supporting position; and
a coupling mechanism that removably holds the shiftable base member relative to the receiving surface in the supporting position so that the base member is supported by the mounting base,
said coupling mechanism including a shiftable latch assembly shiftably mounted to the mounting base and spaced below the receiving surface,
said coupling mechanism including a latch element attached to the shiftable base member,
said shiftable latch assembly and said latch element interengaging one another in a latched position associated with the supporting position so as to restrict movement of the base member out of the supporting position.

2. A modular mounting system as claimed in claim 1,
said mounting base presenting a chamber that receives the latch assembly,
said latch assembly being spaced entirely below the receiving surface, with the receiving surface substantially covering the latch assembly.

3. A modular mounting system as claimed in claim 2,
said latch assembly being mounted so as to move in a plane generally parallel to the receiving surface.

4. A modular mounting system as claimed in claim 3,
said latch assembly being shiftable between the latched position and an unlatched position, with the latch assembly being located in the chamber in the unlatched position.

5. A modular mounting system as claimed in claim 3,
said mounting base including a bottom cover and an elongated platform that presents the receiving surface, with the platform and bottom cover cooperatively defining the chamber.

6. A modular mounting system as claimed in claim 5,
said bottom cover presenting a downwardly facing lowermost surface,
said latch assembly being vertically located entirely between the receiving and lowermost surfaces.

7. A modular mounting system as claimed in claim 5,
at least one of said platform and said cover presenting a socket that partly defines the chamber, with the latch assembly being positioned in the socket.

8. A modular mounting system as claimed in claim 3,
said latch assembly including a latch finger pivotally mounted to the mounting base and pivotal in the plane into and out of the latched position where the latch finger engages the latch element.

9. A modular mounting system as claimed in claim 8,
said latch assembly including a spring that engages the latch finger and urges the latch finger into the latched position.

10. A modular mounting system as claimed in claim 8,
said latch assembly including another latch finger opposed to the first-mentioned latch finger, with the latch fingers being pivotal in the plane and cooperatively capturing the latch element in the latched position.

11. A modular mounting system as claimed in claim 10,
said latch element comprising an elongated latch pin attached to the base member,
said fingers cooperatively presenting a pin-receiving opening in the latched position, with the latch pin extending through the pin-receiving opening.

12. A modular mounting system as claimed in claim 2,
said mounting base presenting outermost margins, with the receiving surface extending between the outermost margins,
said receiving surface defining a surface opening spaced between the outermost margins, with the latch element projecting through the surface opening to extend from the base member to the shiftable latch assembly in the latched position.

13. A modular mounting system as claimed in claim 12,
said latch element comprising an elongated latch pin attached to the base member.

14. A modular mounting system as claimed in claim 12,
said latch assembly including a latch finger pivotally mounted to the mounting base and pivotal in the plane into and out of the latched position where the latch finger engages the latch element adjacent the surface opening.

15. A modular mounting system as claimed in claim 14,
said latch assembly including a spring that engages the latch finger and urges the latch finger out of the latched position.

16. A modular mounting system as claimed in claim 14,
said latch assembly including another latch finger opposed to the first-mentioned latch finger, with the latch fingers being pivotal in the plane and cooperatively capturing the latch element in the latched position.

17. A modular mounting system as claimed in claim 16,
said latch element comprising an elongated latch pin attached to the base member,
said fingers cooperatively presenting a pin-receiving opening in the latched position,
said openings being substantially axially aligned with one another, with the latch pin extending through the openings.

18. A modular mounting system as claimed in claim 1; and
a release mechanism operable to permit decoupling of the base member from the mounting base.

19. A modular mounting system as claimed in claim 18,
said latch assembly including a latch finger pivotally mounted to the mounting base and pivotal in the plane into and out of the latched position where the latch finger engages the latch element.

20. A modular mounting system as claimed in claim 18,
said release mechanism being shiftable between a holding condition where the release mechanism engages the latch finger to restrict pivotal finger movement out of the latched position and a releasing condition where the release mechanism is disengaged from the latch finger to permit pivotal finger movement out of the latched position.

21. A modular mounting system as claimed in claim 20,
said latch assembly including a spring that engages the latch finger and urges the latch finger out of the latched position,
said release mechanism permitting the spring to shift the latch finger out of the latched position in the releasing condition.

22. A modular mounting system as claimed in claim 20,
said release mechanism including an elongated release pin shiftably mounted on the mounting base, with the release pin engaging the latch finger in the holding condition.

23. A modular mounting system as claimed in claim 22,
said release mechanism being spaced below the receiving surface.

24. A modular mounting system as claimed in claim 22,
said release mechanism including a handle attached to the release pin and configured to be grasped by a user to transition said release mechanism between the holding and releasing conditions.

25. A modular mounting system as claimed in claim 22,
said latch assembly including another latch finger opposed to the first-mentioned latch finger, with the latch fingers being pivotal in the plane and cooperatively capturing the latch element in the latched position.

26. A modular mounting system as claimed in claim 25,
said latch fingers presenting distal ends that engage the latch element and opposite proximal ends, with each latch finger being mounted to the mounting base at a pivot between the ends,
said elongated release pin being located between the proximal ends in the holding condition so that the pin restricts pivotal movement of both fingers out of the latched position.

27. A modular mounting system as claimed in claim 20; and
a locking mechanism mounted to the mounting base and shiftable into and out of a locked condition where the locking mechanism restricts movement of the release mechanism out of the holding condition.

28. A modular mounting system as claimed in claim 27,
said locking mechanism including a lever configured to be depressed by a user,
said release mechanism including a handle configured to be grasped by a user to transition said release mechanism between the holding and releasing conditions, with the lever and handle being interengaged in the locked condition.

29. A modular mounting system for modifying the interior of a vehicle, said system comprising:
a mounting base that presents a receiving surface, with the mounting base configured to be rigidly coupled to an interior surface of the vehicle;
a shiftable base member removably attached to the mounting base so as to engage the receiving surface in a supporting position, with the base member being shiftable relative to the mounting base into and out of the supporting position;
a coupling mechanism operably supported by the mounting base, with the coupling mechanism removably coupling the shiftable base member relative to the receiving surface in the supporting position so that the base member is supported by the mounting base; and
a release mechanism operable to permit decoupling of the base member from the receiving base.

30. A modular mounting system as claimed in claim 29,
said coupling mechanism including a latch assembly and a latch element,
said latch assembly including a latch finger pivotally mounted to the mounting base,
said latch element attached to the base member, with the latch finger pivotal into and out of a latched position where the latch finger engages the latch element.

31. A modular mounting system as claimed in claim 29,
said release mechanism being shiftable between a holding condition where the release mechanism engages the latch finger to restrict pivotal finger movement out of the latched position and a releasing condition where the release mechanism is disengaged from the latch finger to permit pivotal finger movement out of the latched position.

32. A modular mounting system as claimed in claim 31,
said latch assembly including a spring that engages the latch finger and urges the latch finger out of the latched position,
said release mechanism permitting the spring to shift the latch finger out of the latched position in the releasing condition.

33. A modular mounting system as claimed in claim 31,
said release mechanism including an elongated release pin shiftably mounted on the mounting base, with the release pin engaging the latch finger in the holding condition.

34. A modular mounting system as claimed in claim 33,
said release mechanism including a handle attached to the release pin and configured to be grasped by a user to transition said release mechanism between the holding and releasing conditions.

35. A modular mounting system as claimed in claim 33,
said latch assembly including another latch finger opposed to the first-mentioned latch finger, with the latch fingers being pivotal in the plane and cooperatively capturing the latch element in the latched position.

36. A modular mounting system as claimed in claim 35,
said latch fingers presenting distal ends that engage the latch element and opposite proximal ends, with each latch finger being mounted to the mounting base at a pivot between the ends,
said elongated release pin being located between the proximal ends in the holding condition so that the pin restricts pivotal movement of both fingers out of the latched position.
